(19) United States
(12) Patent Application Publication
(10) Pub. No.: US 2014/0196661 A1
(43) Pub. Date: Jul. 17, 2014

(54) OVERSPRAY PROTECTION SYSTEM

(71) Applicant: BRIAN WALKER, New Phidelphia, OH (US)

(72) Inventor: BRIAN WALKER, New Phidelphia, OH (US)

(21) Appl. No.: 13/743,541

(22) Filed: Jan. 17, 2013

(51) Int. Cl. B05B 15/12

(52) U.S. Cl. CPC B05B 15/1259
USPC 118/323; 118/326

(57) ABSTRACT

A spray system sprays an object within an enclosure. A plurality of gutters affixed to sidewalls of the enclosure catch excess spray for reuse. The gutters are affixed to sidewalls and hold a garment such that a shield is formed that protects the areas under a platen from overspray.

### CROSS-REFERENCE TO RELATED APPLICATIONS

This application claims the benefit of priority of U.S. Provisional Application 61/590,920 filed Jan. 26, 2012, the entirety of which is incorporated herein by reference.

### BACKGROUND

Current overspray systems for pre-treating garments before a printing process may be open to the environment. Airborne particles may escape from the system, creating sticky or slippery surfaces outside the system, as well as creating air pollution.

As can be seen, there is a need for an improved overspray system.

### SUMMARY

In one aspect of the invention, an overspray protection system comprises a housing; a printing structure disposed to support a printable object within the housing; a plurality of gutters affixed to sidewalls of the housing and adjacent to the printing structure; and a spray mechanism disposed to spray the printable object inside the housing.

In another aspect of the invention, an overspray protection system comprises an enclosed housing, wherein the enclosed housing includes a front wall, a back wall, a top, side walls, and a drawer; a platen within the enclosed housing on the drawer disposed to hold a printable object; a plurality of gutters affixed to the inside of the enclosed housing; and a spraying mechanism disposed to spray the printable object inside the enclosed housing, wherein the spraying mechanism includes a moveable spray mechanism that is disposed to spray the printable object by moving from side to side over the printable object.

It should be understood, of course, that the foregoing relates to exemplary embodiments of the invention and that modifications may be made without departing from the spirit and scope of the invention.

### BRIEF DESCRIPTION OF THE DRAWINGS

FIG. 1 is a perspective front view of an overspray protection system according to an exemplary embodiment of the present invention;

FIG. 2 is a front view of the overspray protection system of FIG.;

FIG. 3 is a perspective front view of the overspray protection system of FIG. 1 showing a drawer in an open position;

FIG. 4 is a detailed view of the drawer of FIG. 2 showing a garment exploded from placement within the overspray protection system of FIG. 1;

FIG. 5 is a detailed view of the drawer of FIG. 2 showing the garment positioning position for spraying;

FIG. 6 is an enlarged view of a gutter of the overspray system from FIG. 3 including a rounded front side of the gutter;

FIG. 7 is cross-sectional front view of the overspray protection system taken along line 7-7 in FIG. 1; and

FIG. 8 is a cross-sectional side view of the overspray protection system taken along line 8-8 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides an overspray protection system for the pretreating of garments before a printing process.

Current devices for pretreating garments before a printing process may not be designed to contain the spray to just the portion of the object being sprayed, which may result in contamination of internal parts of an enclosed housing.

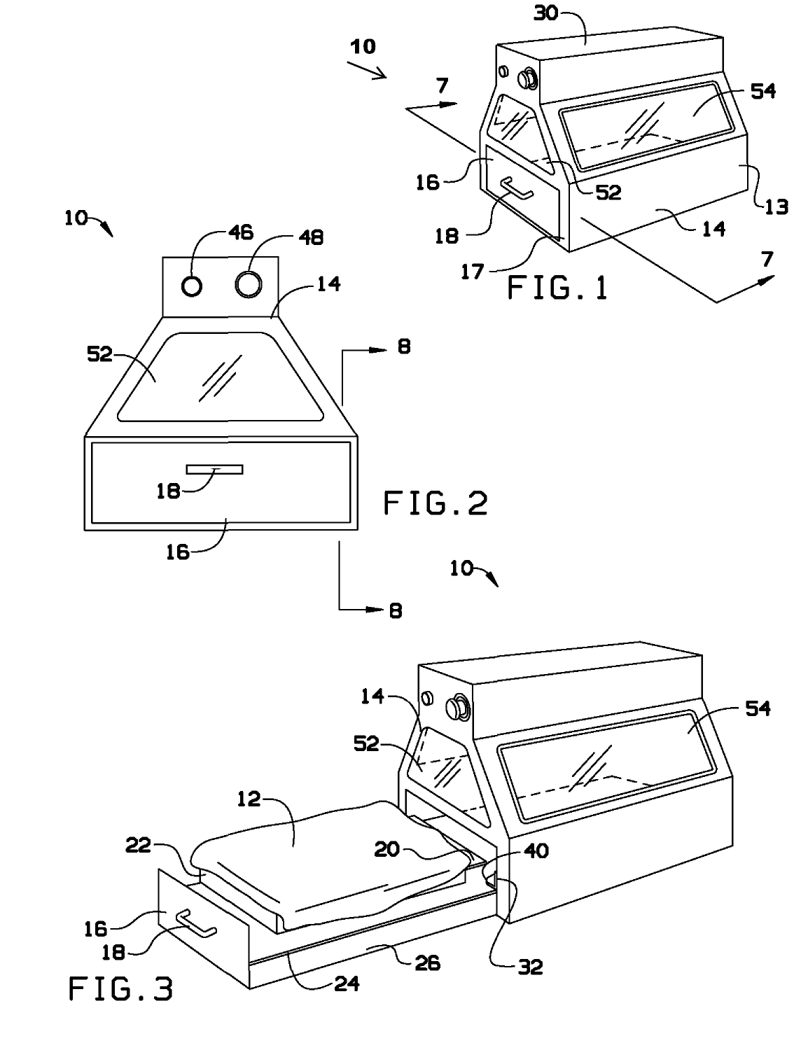

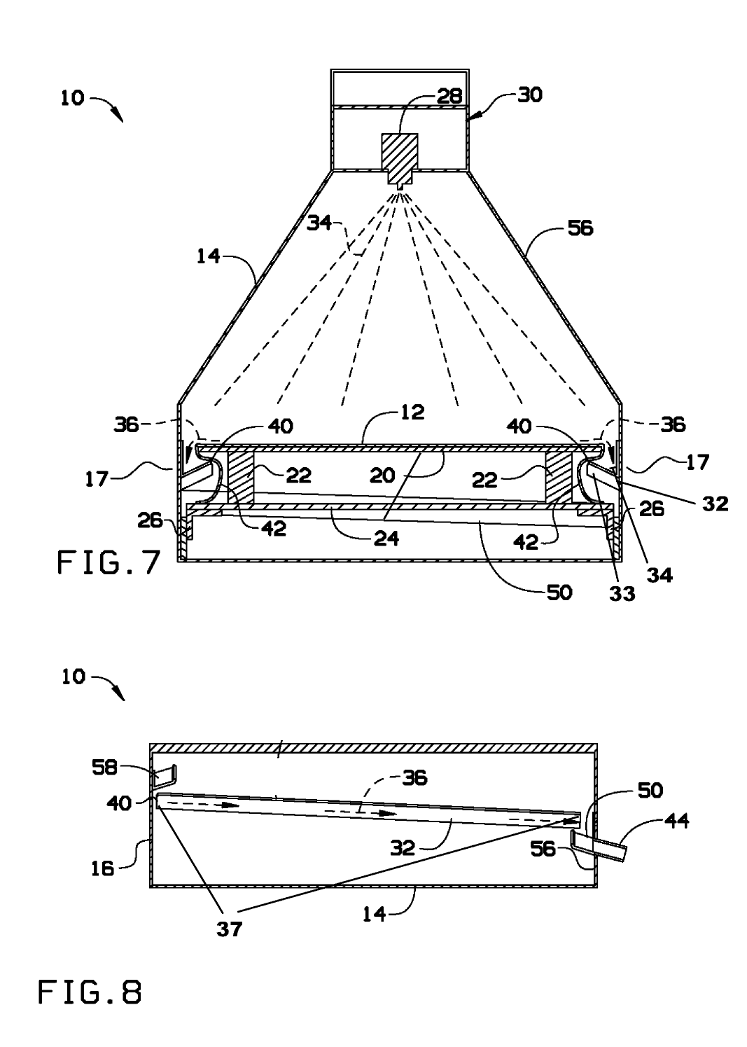

FIG. 1 shows an overspray protection system 10 according to an exemplary embodiment of the present invention. The overspray protection system 10 may include an enclosed housing 14 including a front wall 13, a back wall 56 (FIG. 7), a top section 30, side walls 17, a drawer 16 on one of the side walls, a side window 52 on the side walls 17, and a front window 54 on the front wall 13. The enclosed housing 14 may help to contain the airborne particles that dissipate during the pretreatment spraying process, preventing air pollution.

The drawer 16 may be slid in and out of the enclosed housing 14. A handle 18 may be secured to the drawer 16. The handle 18 may facilitate the opening and closing of the drawer 16.

Referring now to FIG. 2, a start button 46 and a stop button 48 may be located on the enclosed housing 14. The start button 46 and the stop button 48 may allow an operator to respectively start or stop the operation of the overspray protection system 10.

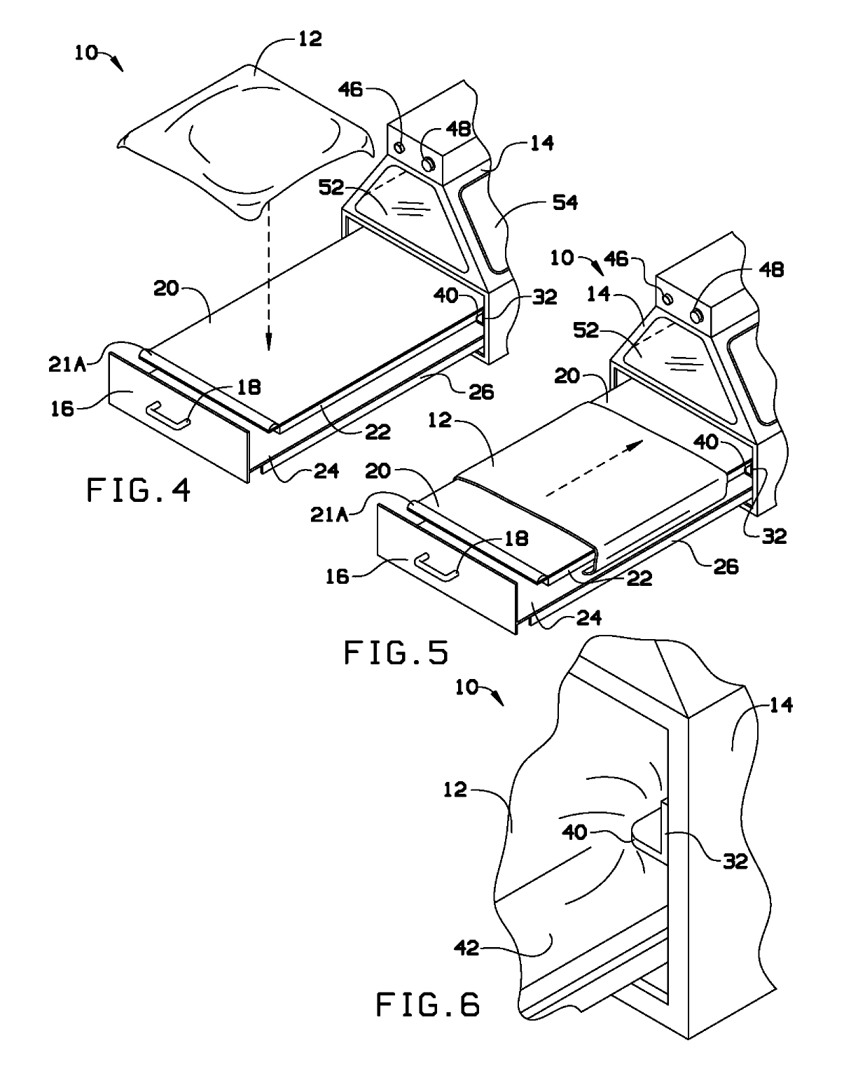

Referring now to FIGS. 3-6, the drawer 16 may include a base 24 and slide brackets 26 secured to the sides of the base. The slide brackets 26 may allow the drawer 16 to slide in and out of the enclosed housing 14.

A stand 22 may be located on top of the base 24. The stand 22 may raise from the base 24 a portion of a printable object such as, for example, a garment 12 to be pretreated. A printing structure such as a platen 20 may be located on top of the stand 22. In an exemplary embodiment, the platen 20 may be part of a conveyor belt system. The platen 20 may receive and hold the garment 12 in place during the pretreatment process. The platen 20 may be stationary or moveable. The garment 12 may be placed on the platen 20 such that the garment 12 rests against gutters 32.

An optional sealing strip 21A (FIGS. 4-5) may be placed on the ends of the platen 20 and may abut the sidewalls 17. The sealing strip 21 A may help to seal the enclosed housing 14 to prevent contaminants from escaping the enclosed housing.

The portion of the garment 12 not being pretreated may hang down from the stand 22, off of the platen 20, and then fold against the outside edge of the gutters 32.

The gutter 32 may include a rounded front side 40. The rounded front side 40 may prevent a folded garment 42 from being stuck when sliding the drawer 16 inside the enclosed housing 14.

Referring now to FIGS. 7-8, a spray mechanism 28 may be located on the upper end 30 inside the enclosed housing 14. The spray mechanism 28 may spray a pretreatment solution 34 onto the garment 12. In some embodiments, the spray mechanism 28 may spray solution 34 as it moves from one side wall 17 of the enclosed housing 14 to the other side wall 17, coating the entire portion of the garment 12 located on top of the platen 20. In an exemplary embodiment, the spray mechanism 28 may also move from front to back on the platen 20. The spray area of the spray mechanism 28 may be usually larger than the area of the platen 20, which may produce the overspray 36. The overspray 36 may be captured on the walls 13, 17, 56 of the enclosed housing 14 and then drip into the gutters 32. The gutters 32 may be mounted to the side walls 17 and the gutters 32 may extend underneath of at least one side of the platen 20. The gutters 32 may be positioned so that an innermost edge 33 of each gutter 32 extends underneath of the platen 20, allowing the platen 20 to hang over the gutter 32. If the platen 20 is moveable, the spray mechanism 28 may move in the same or opposite direction of the platen 20.

In some embodiments, a front gutter 58 and a rear gutter 50 may be placed respectively at the ends of the platen 20. The gutters 32 may be mounted to the side walls 17 at a first angle (FIG. 7) pointed upwards from the side walls 17 from the sidewall. The gutter angle allows the gutters 17 to catch the overspray 36 and bounce and shield components of the system under the platen 20 from the overspray 36. The ends 37 of the gutters 32 may also be fixed at a second angle sloping downwards (FIG. 8) along the enclosed housing 14 in order for the collected overspray 36 and bounce to drain through the gutters 32 to the drain port 44. The drain port 44 may collect the overspray 36 for reuse.

The user (not shown) may open the drawer 16 and load the portion of the garment 12 to be pretreated onto the platen 20. Some of the garment may hang over the sides of the platen 20 and may be tucked into the platen. 20. The user may tuck the portion of the garment 12 not to be pretreated underneath of the platen 20, so it may not be caught on the edge of the gutters 32, 50, 58 as the drawer 16 may be slid inside of the enclosed housing 14. As the platen 20 and garment 12 may be pushed into the enclosed housing 14, the folded garment 42 may be in contact with the gutters 32, 50, 58 which may seal off the area of the enclosed housing from polluting the area outside the enclosed housing. The user may start the pretreatment process by pressing the start button 46. Spray travelling beyond the edges of the platen 20 may be caught by the gutters 32, 50, and 58. The garment 12 extending between the platen 20 and the edge 33 may further shield the areas under the platen 20 from the over bounce. Once the pretreatment process is completed, the user may press the stop button 48 and pull out the drawer 16 allowing access to the garment 12.

The overspray protection system 10 may be used during a variety of spray coating processes, for example, molding or trim, flat panel displays, non-reflective glass, glass panels, roll to roll fabrics, and painting of walls.

It should be understood, of course, that the foregoing relates to exemplary embodiments of the invention and that modifications may be made without departing from the spirit and scope of the invention as set forth in the following claims.

What is claimed is:

1. An overspray protection system comprising:
a housing;
a printing structure disposed to support a printable object within the housing;
a plurality of gutters affixed to sidewalls of the housing and adjacent to the printing structure; and
a spray mechanism disposed to spray the printable object inside the housing.

2. The overspray protection system of claim 1, wherein the housing is an enclosed housing.

3. The overspray protection system of claim 1, wherein the printing structure is a moveable platen.

4. The overspray protection system of claim 1, wherein a drain port adjacent to the printing structure collects for reuse excess solution being used to spray on the printable object.

5. The overspray protection system of claim 1, wherein the printing structure is a stationary platen.

6. The overspray protection system of claim 1, wherein the spray mechanism is disposed to move in an opposite direction of movement of the printing structure, wherein the printing structure is a movable platen.

7. An overspray protection system comprising:
an enclosed housing,
wherein the enclosed housing includes a front wall, a back wall, a top, side walls, and a drawer;
a platen within the enclosed housing on the drawer disposed to hold a printable object;
a plurality of gutters affixed to the inside of the enclosed housing; and
a spraying mechanism disposed to spray the printable object inside the enclosed housing,
wherein the spraying mechanism includes a moveable spray mechanism that is disposed to spray the printable object by moving from side to side over the printable object.

8. The overspray protection system of claim 7,
wherein each of the plurality of gutters extends underneath the printing platen.

9. The overspray protection system of claim 8,
wherein the plurality of gutters include a first gutter and a second gutter that are affixed to the side walls at opposite sides of the printing platen.

10. The overspray protection system of claim 7, wherein the platen is a moveable platen.
